(19) United States
(12) Patent Application Publication
(10) Pub. No.: US 2026/0310527 A1
(43) Pub. Date: Oct. 8, 2026

(54) FEDERATED APPLICATION PROGRAMMING INTERFACE (API) GATEWAY SYSTEM

(71) Applicant: eBay Inc., San Jose, CA (US)

(72) Inventors: Nataraj Agaram Sundar, Santa Clara, CA (US); Hari Narayanan Rangarajan, San Jose, CA (US); Tejas Morabia, Fremont, CA (US); Piyush Shrivastava, Newark, CA (US)

(73) Assignee: eBay Inc., San Jose, CA (US)

(21) Appl. No.: 19/170,735

(22) Filed: Apr. 4, 2025

(51) Int. Cl. G06F 9/54; G06F 21/44

(52) U.S. Cl. CPC G06F 9/54; G06F 21/44

(57) ABSTRACT

A federated application programming interface (API) gateway system is described. In one or more examples, an application programming interface (API) request is received from an application executed by a client device and a client gateway module associated with a digital service provider (DSP) system is selected based on the API request from a federated API gateway system. A transformed API request is formed by applying one or more transformations using the selected client gateway module on the API request. An API response is generated by applying the one or more transformations using the selected client gateway module on a DSP API response received from the DSP system responsive to processing the transformed API request. The API response is transmitted for receipt by the application executed by the client device.

### BACKGROUND

In conventional application development and application programming interface (API) integration scenarios, organizations face significant technical challenges in efficiently managing multiple external APIs. These technical challenges often result from independent implement of API interaction code, which leads to widespread inefficiencies including code duplication, inconsistent error handling, and difficulty maintaining best practices. As application complexity increases, these technical challenges are further increased as developers also struggle with implementing robust logic across numerous integrated APIs over a multitude of digital service provider (DSP) systems.

### SUMMARY

A federated application programming interface (API) gateway system is described. In one or more examples, the federated API gateway system employs client gateway modules that are generated, automatically and without user intervention, to support communication with respective APIs of digital service provider (DSP) systems. The federated API gateway system is configurable in a variety of ways, examples of which include as a third-party intermediary, locally as part of an execution plane system, and so forth.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ a federated application programming interface (API) gateway system as described herein.

FIG. 2 depicts a system in an example implementation showing operation of a federated API gateway system of FIG. 1 in greater detail as generating a client gateway module based on an application programming interface (API) specification.

FIG. 3 depicts an example using a state diagram of operation of a system of FIG. 2 as generating a client gateway module.

FIG. 4 depicts an example implementation of deployment of the client gateway module as generated in FIG. 2 as a third-party intermediary and as part of an execution plane system.

FIG. 5 is a flow diagram depicting an algorithm as a step-by-step procedure in an example implementation of operations performable for accomplishing a result of client gateway module generation.

FIG. 6 depicts a system showing operation of a federated API gateway system of FIG. 1 in greater detail as performing API request and API response translation through use of a client gateway module.

FIG. 7 depicts an example of operation of the system of FIG. 6 using a state diagram.

FIG. 8 is a flow diagram depicting an algorithm as a step-by-step procedure in an example implementation of operations performable for accomplishing a result of API request and API response translation using a client gateway module as generated in FIG. 2.

FIG. 9 is a flow diagram depicting an algorithm as a step-by-step procedure in an example implementation of operations performable for accomplishing a result of API request routing through use of a federated application programming interface (API) gateway system implemented both as a third-party intermediary and as an execution plane system.

FIG. 10 illustrates an example system including various components of an example device that can be implemented as any type of computing device as described and/or utilize with reference to FIGS. 1-9 to implement embodiments of the techniques described herein.

### DETAILED DESCRIPTION

### Overview

Organizations face significant technical challenges in attempting to efficiently consume and manage multiple external APIs in a rapidly evolving landscape of application development and application programming interface (API) integration. In conventional techniques, for instance, each team or digital service within the organization use dedicated code for interacting with external APIs that is coded independently in typical real-world scenarios, leading to widespread code duplication, inconsistent error handling, and difficulty in maintaining optimized practices across the organization. This fragmented approach also increases development time and computational resource consumption, introduces potential security vulnerabilities, and increases challenges in adapting to API changes or implementing organization-wide optimizations.

Furthermore, as application complexity continues to expand and rely on an increasing number of external services, managing the various authentication mechanisms, rate limits, and versioning specifications becomes a daunting task. Developers, for instance, often struggle with implementing retry logic, efficient connection pooling, and comprehensive monitoring for each integrated API. The lack of a centralized approach to API consumption results in increased latency, as each application may make multiple network hops in some scenarios to reach different APIs. Additionally, organizations face significant technical difficulties in maintaining consistent performance across different environments (e.g., development, staging, production) and struggle to implement effective warm-up procedures to ensure optimal performance during application startup or after deployments.

Accordingly, to address these and other technical challenges, a federated application programming interface (API) gateway system is described. The federated API gateway system is implemented using a plurality of client gateway modules corresponding to APIs of respective digital service provider (DSP) systems.

The plurality of client gateway modules, for instance, are generated automatically and without user intervention based on a respective programming interface (API) specification associated with an application programming interface (API) of a respective digital service provider (DSP) system. Each client gateway module is configurable to perform transformations, validation and schema handling based on the API specification, receive an API request from an application and communicate the API request to the API of the DSP system, and communicate a digital service provider (DSP) result from the DSP system back to the application.

Examples of transformations performed through execution of the client gateway modules include authentication of the API request, caching of the API request, and/or rate limiting of the API request. The client gateway modules are also configurable to implement a service level agreement that specifies performance metrics, responsibilities, guarantees, penalties, reporting, issue resolution, and terms of service. In this way, automated generation of the client gateway modules by the federated API gateway system automatically from API specifications significantly reduces development time and potential for errors, thereby improving accuracy and computational resource efficiency.

The federated API gateway system is configurable to deploy the client gateway modules in a variety of ways. As a third-party intermediary, for instance, the federated API gateway system centralizes API management, reduces code duplication and inconsistencies across an organization while providing unified authentication, rate limiting, and versioning control. This centralization enables efficient updates, consistent error handling, and improved security practices across API integrations with corresponding improvements in computational resource consumption efficiency.

When implemented with a local deployment model as part of an execution plane system, the federated API gateway system further optimizes performance by allowing time-sensitive API calls to be handled locally, minimizing network latency. This hybrid approach of centralized management with localized execution supports a variety of technical advantages including standardized API consumption while maintaining the low-latency operations. Additionally, configuration of the client gateway modules as part of a “plug-and-play” extension framework allows supports efficient integration of custom functionality such as caching, advanced transformations, and specialized logging, enhancing flexibility and adaptability to diverse organizational targets which is not possible in conventional techniques. Further discussion of these and other examples is included in the following sections and shown in corresponding figures.

### Term Examples

A “machine-learning model” refers to a computer representation that is tunable (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of language machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Federated API Gateway Environment

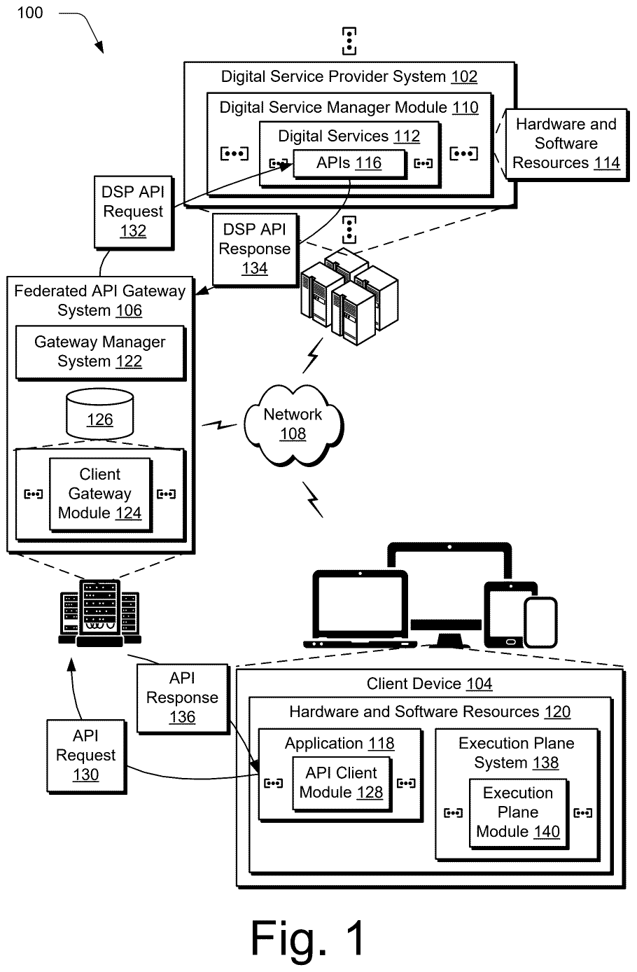

FIG. 1 is an illustration of a digital medium environment 100 in an example implementation that is operable to employ a federated application programming interface (API) gateway system as described herein. The illustrated environment 100 includes a digital service provider system 102, a client device 104, and a federated API gateway system 106 that are communicatively coupled, one to another, via a network 108. Computing devices that implement the digital service provider system 102, client device 104, and federated API gateway system 106 are configurable in a variety of ways.

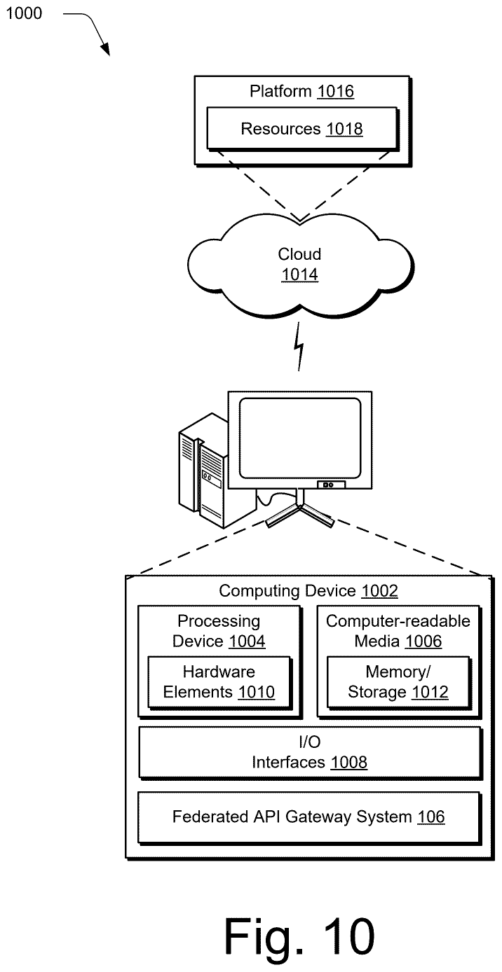

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources, e.g., mobile devices. Additionally, although a single computing device is shown and described in instances in the following discussion, a computing device is also representative of a plurality of different devices, such as multiple servers utilized by a business to perform operations “over the cloud” as further described in relation to FIG. 10.

The digital service provider system 102 is illustrated as including a digital service manager module 110 to implement a variety of digital services 112 using hardware and software resources 114. The digital services 112 are accessible by respective APIs 116 via a network 108. The digital service manager module 110 is configurable to act as a central control unit, coordinating the allocation of computational resources, managing data storage, and overseeing the execution of service-specific algorithms and processes. The digital services 112 encompass a wide range of functionalities that are accessible by external applications through well-defined application programming interfaces (APIs) 116 over a network 108.

The APIs 116 serve as standardized interfaces that define how external systems interact with the digital services 112. These APIs 116 specify the types of requests that may be made, a format of the data to be sent and received, protocols to be used for communication, and so forth. By exposing the digital services 112 through respective APIs 116, the digital service provider system 102 enables seamless integration with various applications 118 as executed using hardware and software resources 120 of the client device 104. In this way, the application 118 is able to leverage digital services 112 without understanding the underlying implementation details. This abstraction promotes modularity, scalability, and interoperability in application development.

A wide variety of functionality of digital services 112 is made accessible via APIs 116. For example, a payment processing digital service may offer APIs for initiating transactions, checking payment status, and managing refunds. A cloud storage provider may expose APIs for uploading, downloading, and managing files. In the realm of artificial intelligence, a natural language processing service may provide APIs for text translation, sentiment analysis, or named entity recognition. Likewise, e-commerce platforms may offer APIs for product catalog management, order processing, and inventory updates. Social media platforms typically provide APIs for posting content, retrieving user data, and managing advertising campaigns. A variety of other examples are also contemplated.

As previously described, integration and management of a multitude of APIs from various digital service provider systems 102 presents significant technical challenges. As the number of digital services and corresponding APIs grows, developers face increasing complexity in handling diverse authentication methods, data formats, and communication protocols. Each API, for instance, may have its own unique parameters for request formatting, error handling, and response parsing. These unique parameters may lead to a proliferation of custom code and potential inconsistencies across different parts of an application. This heterogeneity complicates initial development and also makes ongoing maintenance and updates time-consuming and error prone.

Furthermore, management of the performance and reliability of multiple API integrations increases these technical challenges. Different APIs, for instance, may have varying rate limits, latency characteristics, and availability patterns, involving sophisticated retry logic and fallback mechanisms to ensure robust operation. Monitoring and debugging issues across a diverse set of APIs may also be complex, often involving specialized tools and expertise for each integration.

Additionally, as APIs evolve over time, significant technical burdens are encountered in tracking version changes and deprecations across multiple digital service provider systems, potentially leading to unexpected failures or security vulnerabilities. These technical challenges are further exacerbated when organizations are tasked with maintaining consistent behavior and performance across different environments (e.g., development, staging, production) while also adhering to various compliance and security standards that may apply differently to each API integration.

Accordingly, to address these and other technical challenges a federated API gateway system 106 implements a gateway manager system 122. The gateway manager system 122 is configured to generate, implement, and manage operation of a plurality of client gateway modules 124, which are illustrated as stored in a storage device 126. The federated API gateway system 106, for instance, is configurable to generate each of the client gateway modules 124, automatically and without user intervention, as corresponding to a particular API 116 of a particular digital service 112 of a respective digital service provider system 102.

To do so, the federated API gateway system 106 may leverage a variety of information. The federated API gateway system 106, for instance, may obtain an application programming interface (API) specification, a service level agreement, configuration inputs, and so forth. The federated API gateway system 106 then generates executable code to implement the plurality of client gateway modules 124 such that calls made to the APIs are compatible based on the API specification. The federated API gateway system 106, for instance, is configurable to set validation and schema handling, incorporate of retry logic, timeout handling, error management, and so forth.

In the illustrated example, the application 118 includes one or more API client modules 128. The API client modules 128 are representative of functionality coded into the application 118 to make API calls to external digital services. When the application 118 is tasked with interacting with a specific API, for instance, the application 118 invokes the corresponding API client module 128. In a map scenario, for instance, the API client module 128 is configured to call an API of a corresponding mapping digital service.

In conventional API integration scenarios, however applications across various client devices face numerous technical challenges when making API calls. These challenges are a direct result of the diverse nature of APIs, each potentially involving unique authentication methods, data formats, and communication protocols. Accordingly, applications are tasked in conventional techniques with individually implementing and maintain code for handling these disparate API techniques, leading to code duplication and inconsistencies across different applications and devices. This fragmented approach of conventional techniques also increases development complexity and a likelihood of errors, especially when dealing with API versioning, rate limiting, and error handling. Mobile applications, web browsers, and IoT devices, for instance, may each involve tailored implementations to account for specific constraints in processing power, memory, and network connectivity. Furthermore, ensuring optimal performance across different network conditions and managing connection pooling efficiently becomes increasingly difficult as the number of integrated APIs grows.

The lack of a standardized approach in conventional techniques also complicates monitoring and debugging efforts, making it challenging to identify and resolve issues quickly across diverse client environments. These problems are exacerbated when applications operate in offline or low-connectivity scenarios, thereby involving caching and synchronization mechanisms to maintain data consistency and user experience across different devices and platforms.

To address these technical challenges, the federated API gateway system 106 employs a federated approach. The federated API gateway system 106, for instance, generates the plurality of client gateway modules 124 based on respective API specifications, thereby ensuring consistency and type safety. The federated API gateway system 106 is also configurable to operate as a managed service, e.g., as a third-party intermediary as part of a hosted gateway that is called by the application 118 to execute an API request 130.

The gateway manager system 122, for instance, may receive the API request 130 from the application 118 and identify a respective APIs 116 of the respective digital service provider system 102 that is to process the API request 130. A client gateway module 124 corresponding to the API 116 and digital service provider system 102 is located and used to generate a DSP API request 132 that is compatible with the API 116, e.g., using one or more transformations. A DSP API response 134 is received responsive to processing the request, and the client gateway module 124 is again used to then transform the DSP API response 134 into an API response 136 that is compatible with the application 118.

The federated API gateway system 106 is configurable to deploy the client gateway modules 124 in a variety of ways. As a third-party intermediary, as illustrated, the federated API gateway system 106 centralizes API management, reduces code duplication and inconsistencies across an organization while providing unified authentication, rate limiting, and versioning control. This centralization enables efficient updates, consistent error handling, and improved security practices across API integrations with corresponding improvements in computational resource consumption efficiency.

When implemented in accordance with a local deployment model by an execution plane system 138, the client gateway modules 124 are implemented as execution plane modules 140 that are executed locally by the client device 104, e.g., along with the application 118 as part of the hardware and software resources 120. Deployment in this manner is configurable to implement a variety of functionality. The execution plane system 138, for instance, may optimize performance by allowing time-sensitive API calls to be handled locally, minimizing network latency. This hybrid approach of centralized management with localized execution supports a variety of technical advantages including standardized API consumption while maintaining low-latency operation.

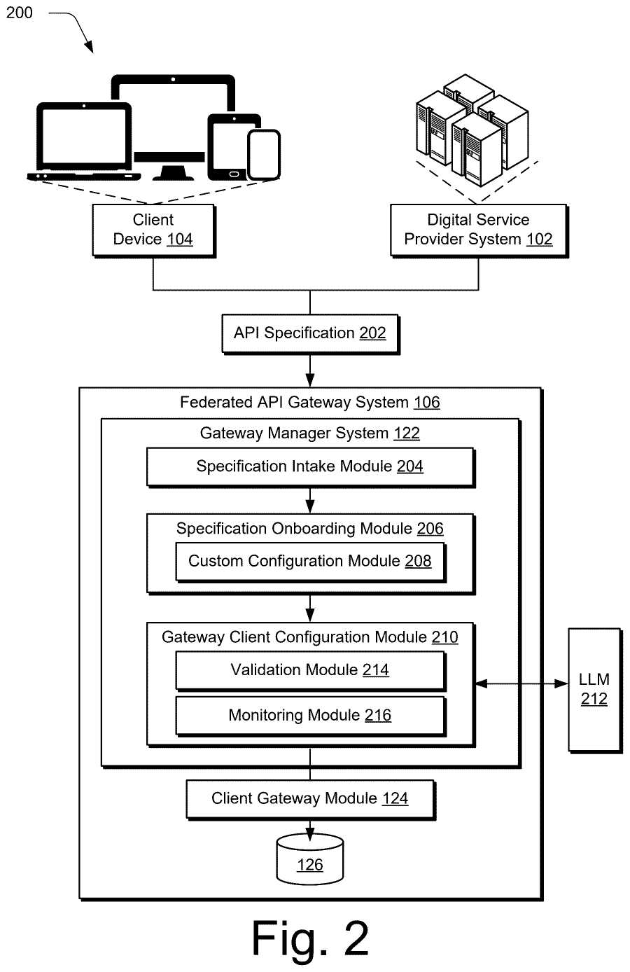

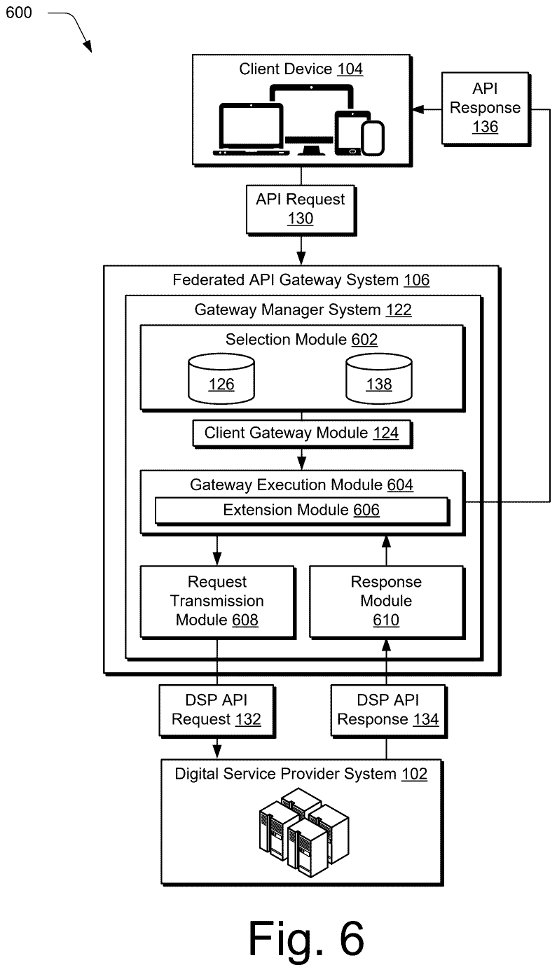

Configuration of the client gateway modules as part of a “plug-and-play” extension framework supports efficient integration of custom functionality such as caching, advanced transformations, and specialized logging, enhancing flexibility and adaptability to diverse organizational desires which is not possible in conventional techniques. Further discussion of generation of the plurality of client gateway modules 124 is described in relation to FIGS. 2-5 and corresponding section in the following discussion and use of the plurality of client gateway modules 124 as part of the federated API gateway system 106 is described in relation to FIGS. 6-9 and corresponding section in the following discussion.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Client Gateway Module Generation

The following discussion describes client gateway module generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

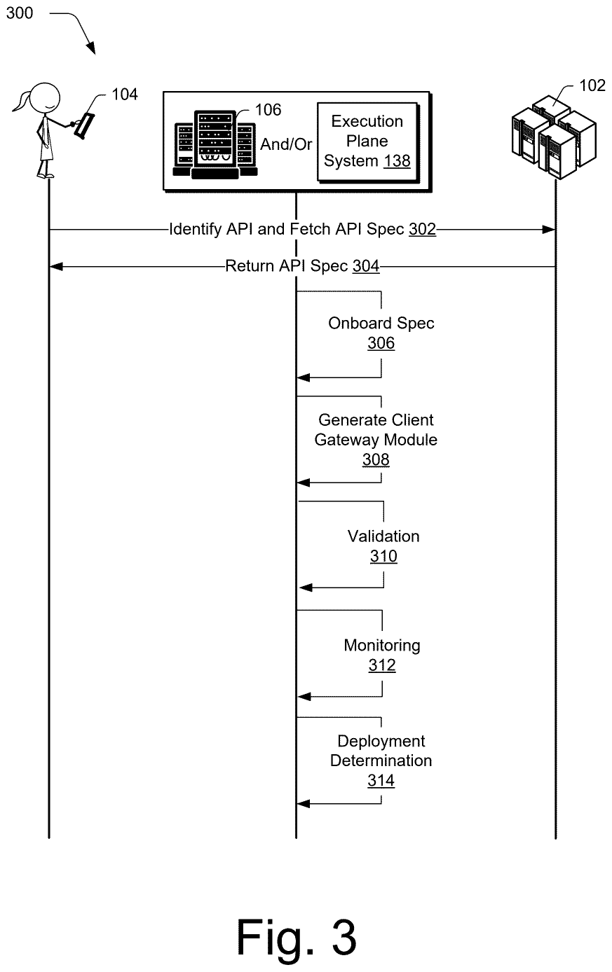

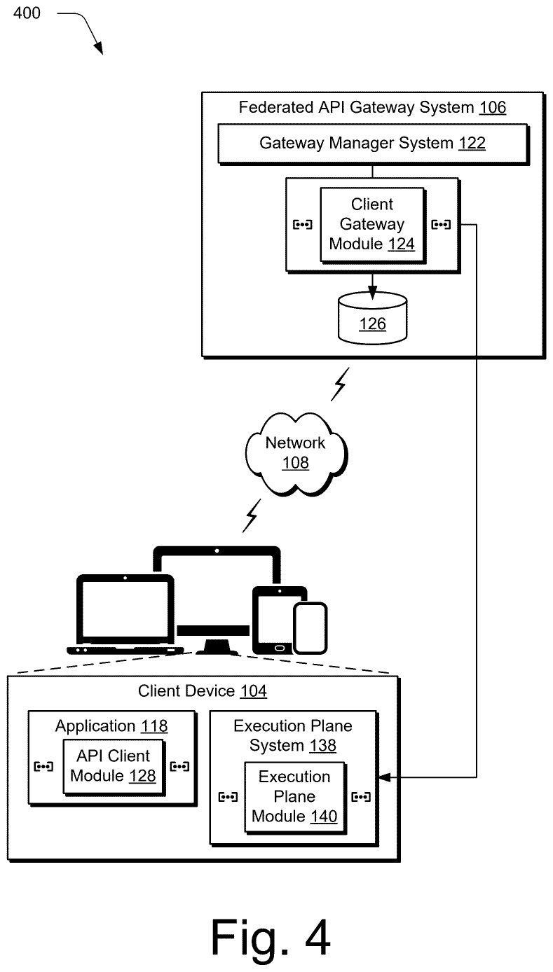

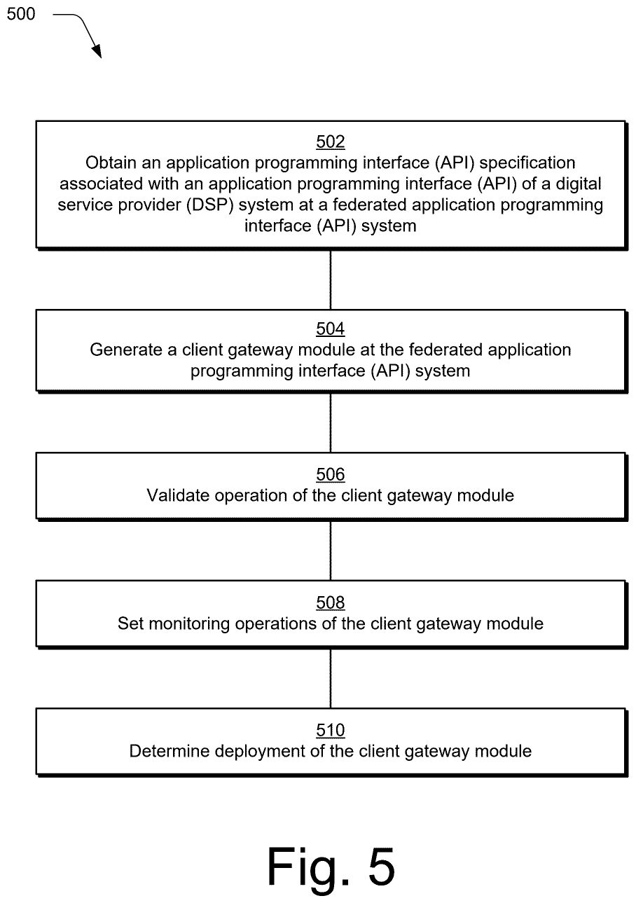

FIG. 2 depicts a system 200 in an example implementation showing operation of the federated API gateway system 106 of FIG. 1 in greater detail as generating a client gateway module based on an application programming interface (API) specification. FIG. 3 depicts an example 300 of operation of the system 200 of FIG. 2 using a state diagram. FIG. 4 depicts an example implementation 400 of deployment of the client gateway module as generated in FIG. 2 as a third-party intermediary and as part of an execution plane system 122. FIG. 5 is a flow diagram depicting an algorithm 500 as a step-by-step procedure in an example implementation of operations performable for accomplishing a result of client gateway module generation. In portions of the following discussion, reference is made in parallel to FIGS. 2-5.

To begin in this example, an application programming interface (API) specification 202 is obtained by a specification intake module 204 at a federated application programming interface (API) system 106. The application programming interface (API) specification 202 is associated with an application programming interface 116 (API) of a digital service provider (DSP) system 102 (block 502). The API specification 202, for instance, may be obtained from the client device 104 via a user interface output by the federated API gateway system 106, obtained from the digital service provider system 102 that supports the respective APIs 116, and so forth. In the illustrated example of FIG. 3, for instance, the client device 104 identifies an API and makes a request to fetch the API spec (step 302) from the digital service provider system 102. In response, the digital service provider system 102 returns the API spec (step 304).

The API specification 202 is configurable to describe endpoints, parameters, and payload structures supported by an application programming interface (API) 116 of the DSP system 102. Consider an example in which the plurality of client gateway modules 124 is to be generated to obtain weather forecasts from an API 116 of the digital service provider system 102. The specification intake module 204 is configured to navigate to a developer portal of the digital service provider system 102 and download the API specification 202 as an “OpenAPI” specification, e.g., as a YAML file, JSON, and so forth.

An OpenAPI specification is a standardized, machine-readable document that describes a structure, functionality, and capabilities of a respective API. The OpenAPI specification typically defines API endpoints, HTTP methods, request/response schemas, authentication mechanisms, and other details involved in interacting with the API 116. As a result, the OpenAPI specification promotes understanding, integration, and interaction with the API without source code access. The OpenAPI specification facilitates automated code generation, API documentation, testing, and tooling support across various programming languages and platforms.

In one or more implementations, the specification intake module 204 is also configurable to intake a service level agreement associated with the API 116, which may specify performance metrics, responsibilities, guarantees, penalties, reporting, issue resolution, and terms of service. A service level agreement for an API, for instance, may specify that the API is to maintain a particular amount of uptime measured on a monthly basis, with a maximum response time for a portion of the API requests. In one or more examples, the digital service provider system 102 is responsible for maintaining the infrastructure, implementing security measures, and providing technical support during business hours.

The digital service provider system 102, for instance, may guarantee a data accuracy rate and commit to resolving issues within a specified amount of time. If these performance metrics are not met, the provider may offer service credits, e.g., a ten percent discount on monthly fees. The digital service provider system 102, as part of the service level agreement, may generate and share monthly performance reports detailing uptime, response times, and any incidents. For issue resolution, a tiered support system may be established by the digital service provider system 102 with a dedicated technical contact for severe technical issues. The terms of service may include usage limits per API, data retention policies, and a notice period for changes to the API structure or functionality, and so forth.

A specification onboarding module 206 is then employed to onboard the spec (step 306). Onboarding of the spec, for instance, may include input of custom configurations, e.g., service level agreement criteria as described above, error-handling rules, retries, timeouts, and so forth. In this way, the gateway manager system 122 is provided with information describing operation supported by the API 116 through use of the API specification 202 and operational agreements as indicated by a service level agreement, which may be entered as part of the specification onboarding module 206.

A gateway client configuration module 210 is then employed to generate a client gateway module 124 at the federated application programming interface (API) system (step 308, block 504). The gateway client configuration module 210, for instance, is configurable to analyze the API specification 202 and any additional configuration inputs from the specification onboarding module 206. The gateway client configuration module 210 parses the API specification 202 to understand a structure, endpoints, data models, and authentication techniques of the API 116. The gateway client configuration module 210 then uses this information to automatically generate executable code that is configured to interact with the API 116, including methods for each endpoint, request/response handling, data serialization/deserialization, and other transformation.

Generation of the executable code may be performed in a variety of ways, an example of which leverages use of a large language module, illustrated as LLM 212 in FIG. 2. The gateway client configuration module 210, for instance, may generate a prompt with instructions to cause the LLM 212 to generate the client gateway module 124 and may include the API specification 202 as part of the prompt.

In a scenario involving a service level agreement, the gateway client configuration module 210 (e.g., through use of the LLM 212) may incorporate service level agreement criteria into the generated client gateway module 124. For instance, if the service level agreement specifies a maximum response time for a portion of the requests, the gateway client configuration module 210 generates executable code that includes built-in timeout handling and retry logic.

The gateway client configuration module 210 may also implement circuit breaker patterns to reduce cascading failures during API outages and add telemetry code to track response times and error rates. The generated plurality of client gateway modules 124, for instance, may include functionality to automatically report service level agreement violations, such as when response times consistently exceed the agreed threshold, enabling proactive management of the API integration and ensuring compliance with the service level agreement.

As part of generating the plurality of client gateway modules 124, the gateway client configuration module 210 is also configured to validate operations of the plurality of client gateway modules 124 through use of a validation module 214 (step 310, block 506)) and incorporate monitoring functionality through use of a monitoring module 216 (step 312, block 508).

The validation module 214, for instance, operates by analyzing the API specification 202 to create request and response validation layers as part of the client gateway module 124. To do so, the validation module 214 extracts data schemas, parameter constraints, and expected response formats from definitions of the API specification 202. For incoming requests, the validation module 214 generates validation logic to ensure that each desired field is present, ensure data types match the API specification 202, and values fall within defined ranges or patterns. For example, validation module 214 may validate that a user ID is a valid UUID format, or that a date field follows the correct ISO 8601 format.

On the response side, the validation module 214 creates checks to verify that the API responses conform to an expected structure and data type. If a API response includes unexpected fields or missing data, the validation layer flags these inconsistencies during execution of the plurality of client gateway modules 124. This bidirectional validation ensures data integrity throughout the API communication process, catching potential issues and reducing propagation of malformed data. The validation module 214 may also implement complex validation rules, such as cross-field dependencies or conditional requirements, based on the detailed schemas provided in the API specification.

The monitoring module 216 includes functionality configurable to enhance operation of the client gateway module 124 by implementing comprehensive observability features. The monitoring module 216, for instance, sets up logging hooks to capture detailed information about each API call, including request parameters, response data, timestamps, and errors encountered. These logs may be structured and tagged for querying and analysis. The monitoring module 216 also configures metrics capture, collecting data points such as request latency, throughput, error rates, and resource utilization.

To visualize this data, the monitoring module 216 is configurable to generate customizable dashboards that display real-time and historical performance metrics as part of execution of the client gateway module 124. These dashboards may include graphs showing API call volumes over time, heatmaps of response times, and alerts for when certain thresholds are breached. The monitoring module 216 may also integrate with external monitoring systems.

FIG. 4 depicts an example implementation 400 of deployment of the client gateway module as generated in FIG. 2 as a third-party intermediary and as part of an execution plane system. After generation of the client gateway module 124, a deployment determination is made (step 314, block 510) by the federated API gateway system 106 and/or execution plane system 138. A determination, for instance, may be made that a respective API request to be processed by the API 116 and the client gateway module 124 is time sensitive. In response, the client gateway module 124 is configured for use as an execution plane module 140 by the execution plane system 138.

Executing the client gateway module 124 as an execution plane module 140 locally at a client device 104 offers several technical advantages as previously described. Use of the execution plane module 140 locally significantly reduces network latency by eliminating an additional network hop to a remote gateway server, enabling faster API responses and improved application performance. Deployment of the execution plane modules 140 locally as part of the execution plane system 138 also supports local caching of frequently accessed data, reducing a number of API calls and conserving network bandwidth. The execution plane module 140 also supports offline scenarios by queuing requests when connectivity is lost and then synchronizing once the connection is restored. The execution plane module can also implement local rate limiting and request shaping, preventing accidental API abuse and optimizing resource utilization.

Security may also be enhanced as sensitive data may be processed locally before being sent to external APIs, reducing exposure to potential network-level threats. Additionally, the execution plane module 140 may adapt to device-specific constraints, such as battery life or network conditions, dynamically adjusting operational behavior to optimize performance in various environments. This local execution model supports a responsive and resilient API integration experience, particularly beneficial for mobile applications or IoT devices with limited or intermittent connectivity.

In another instance, a determination may be made that a respective API request to be processed by the API 116 and the client gateway module 124 is a background process and as such is not time sensitive. Therefore, in this example, the client gateway module 124 is executed by the federated API gateway system 106 as a third-party intermediary. Execution of the client gateway module 124 as a third-party intermediary supports a variety of technical advantages. Remote execution, for instance, provides a centralized point of control and management for API integrations across multiple client devices and applications, enabling consistent policy enforcement, monitoring, and updates. This centralized approach simplifies version management of API clients, allowing for seamless updates and rollbacks without involving changes to individual client applications.

The federated API gateway system 106, as a third-party intermediary, may also implement advanced load balancing and traffic shaping across multiple instances of digital service provider systems, improving overall system reliability and performance. As a third-party intermediary, requests may be aggregate from multiple client devices, potentially reducing workload on backend services and optimizing resource utilization.

As a third-party intermediary, the client gateway module 124 may also provide a layer of abstraction between clients and service providers, allowing for API transformations, protocol translations, and service migrations without impacting client applications. Additionally, the client gateway module 124 as a third-party intermediary may implement centralized caching, thereby reducing redundant API calls and improving response times for frequently requested data. As a third-party intermediary, the client gateway module 124 also enhances security by providing a single point for implementing authentication, authorization, and encryption policies, as well as offering advanced threat detection and mitigation capabilities across API traffic.

Therefore, the client gateway module 124 may be integrated as part of the federated API gateway system 106 in a variety of ways. In a typical e-commerce application, a user's shopping experience typically involves both time-sensitive operations and background processes. The application 118 may therefore employ a hybrid approach using the federated API gateway system 106 as a third-party intermediary as well as part of the execution plane system 138 to optimize performance and resource utilization.

For time-sensitive operations like real-time inventory checks, price updates, and add-to-cart functionality, the deployment of the client gateway module 124 as an execution plane module 140 is employed. The execution plane module 140, executing locally with the application 118 at the client device 104, handles these time-sensitive API requests without incurring additional network hops. The execution plane module 140, for instance, maintains a local cache of frequently accessed data and performs rapid local validations, ensuring near-instantaneous response times for these crucial user interactions.

Meanwhile, for background operations that are less time sensitive such as user preference updates, product recommendations, or analytics data collection, the client gateway module 124 is implemented remotely as part of a third-party intermediary, e.g., as a centralized gateway. This centralized gateway approach is configurable to manage background API calls, handling tasks such as client generation, versioning, and monitoring across multiple services without impacting an immediate user experience.

By intelligently routing requests between the local execution plane system 138 and the federated API gateway system 106 as implemented as a remote gateway, the application 118 achieves both rapid response times for time sensitive operations and efficient management of background operations. Further discussion of operation of the client gateway module 124 as part of a third-party intermediary and/or locally as part of an execution plane system 138 is included in the following section and shown in corresponding figures.

### Example Federated API Gateway System Operation

The following discussion describes an example of federated API gateway system operation that leverage client gateway modules as generated with respect to FIGS. 2-5 that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

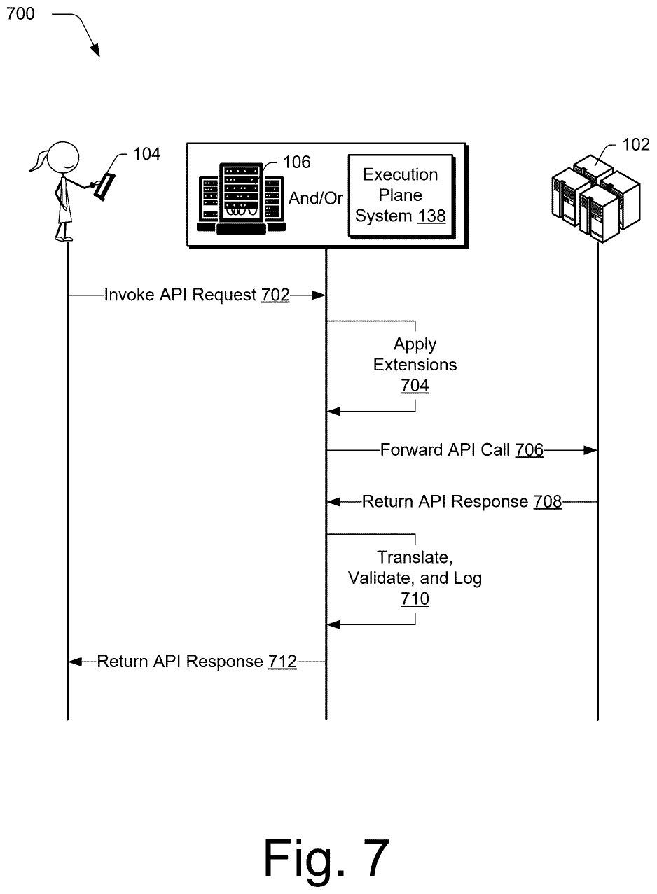

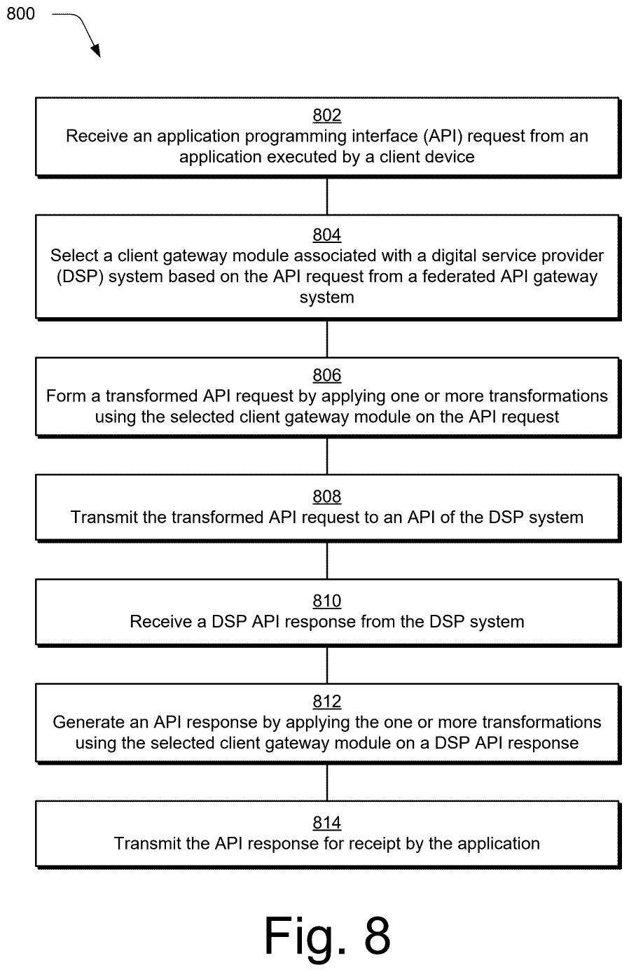

FIG. 6 depicts a system 600 showing operation of the federated API gateway system 106 of FIG. 1 in greater detail as performing API request and API response translation through use of a client gateway module 124. FIG. 7 depicts an example 700 of operation of the system 600 of FIG. 6 using a state diagram. FIG. 8 is a flow diagram depicting an algorithm 800 as a step-by-step procedure in an example implementation of operations performable for accomplishing a result of API request and API response translation using a client gateway module as generated in FIG. 2.

To begin in this example, an application programming interface (API) request is received from an application executed by a client device (block 802). The application 118 as executed by the client device 104, for instance, transmits an invoke API request (step 702), e.g., to the federated API gateway system 106 and/or the execution plane system 138. The API request 130 may be triggered by various user actions or automated processes within the application 118. For example, in a mobile banking app, a user might initiate a funds transfer, prompting the application 118 to send an API request 130 to retrieve the user's account balance. In another scenario, a weather forecasting application automatically send an API request 130 every hour to fetch updated meteorological data for a user's location.

The application 118 transmits this invoke API request 130 to the federated API gateway system 106, and more particularly the gateway manager system 122. The gateway manager system 122, upon receiving the API request 130, initiates a processing pipeline.

A client gateway module associated with a digital service provider (DSP) system is selected based on the API request from a federated API gateway system (block 804). A selection module 602, for instance, may select the client gateway module 124 from the storage device 126 maintained at the federated API gateway system 106 as a third-party intermediary or from execution plane system 138 maintained locally at the client device 104. To do so, the selection module 602 first identifies the client gateway module 124 to handle the request based on factors such as the target API, the type of operation requested, or specific client configurations. The identified client gateway module 124 is then executed to perform transformations or extensions to the API request 130 as further described below.

A transformed API request is formed by a gateway execution module 604 by applying one or more transformations using the selected client gateway module 124 on the API request 130 (block 806) through use of an extension module 606. The extension module 606, for instance, may apply the extensions to the API request 130 (step 704).

A request transmission module 608 is then employed to transmit the transformed API request (e.g., as a DSP API request 132) to an API 116 of the DSP system 102 (step 706, block 808). The request transmission module 608, for instance, leverages the selected client gateway module 124 to apply one or more transformations to the API request 130, thereby transforming the request it to meet the specific criteria of the digital service provider system 102. The transformation process may involve various operations such as data format conversion, request parameter mapping, protocol adaptation to ensure compatibility with the destination API 116, and so forth.

The extension module 606 is representative of functionality for applying extensions to the API request 130. These extensions may encompass a wide range of functionalities that enhance or modify the request. For example, the extension module 606 may add authentication tokens or signatures to the request headers, implement request throttling to adhere to rate limits, or inject tracing identifiers for enhanced observability. In additional scenarios, extension module 606 may perform data enrichment by augmenting the request with additional information from external sources, apply business logic transformations specific to the client's use case, and so forth. In this way, the extension module 606 supports customized request processing, enabling the federated API gateway system 106 to adapt to diverse integration criteria and optimize the communication between the client device 104 and the digital service provider system 102.

A DSP API response 134 is then received from the DSP system 102 (step 708, block 810) by a response module 610. The DSP API response 134, in one or more examples, may contain a variety of types of data depending on the nature of the API request 130. For instance, if the API request 130 was for user authentication, the DSP API response 134 from the digital service provider system 102 might include an access token, user profile information, and permissions. In a scenario involving a data retrieval request, the DSP API response 134 may contain requested records, metadata, and pagination information.

The response module 610 acts as the initial point of contact for incoming DSP API response 134 from the DSP system 102. As such, the response module 610 may perform preliminary processing of the DSP API response 134 before passing it on for further handling, e.g., by the gateway execution module 604 and/or the extension module 606. Examples of preliminary processing include checking the response status code to determine if the request was successful, parsing the response body, and extracting relevant headers. For example, if the DSP system 102 uses custom headers to convey rate limit information or caching directives, the response module 610 interprets and stores this information for future use. In scenarios where the DSP system 102 employs encryption or compression on the DSP API response 134, the response module 610 may also handle decryption or decompression tasks to prepare the raw response data for subsequent processing steps within the federated API gateway system 106.

An API response 136 is then generated by applying the one or more transformations using the selected client gateway module 124 on the DSP API response 134 (step 710, block 812), e.g., by the gateway execution module 604 and/or the extension module 606. The gateway execution module 604, for instance, is configured to translate, validate, and log the DSP API response 134 (step 710). This transformation process is configurable to leverage the selected client gateway module 124, which applies one or more transformations to ensure the response meets client expectations and processing criteria. These transformations may include data format conversions, response filtering, enrichment with additional metadata, and so forth.

The extension module 606 is representative of functionality to apply various extensions to customize the DSP API response 134. For example, the extension module 606 is configurable to translate error codes from the DSP system 102, add caching headers to improve client-side performance, inject telemetry data for monitoring purposes, and so forth. In additional scenarios, the extension module 606 aggregates data from multiple DSP API responses, performs calculations or data analysis on the response content, or applies business logic transformations specific to the application 118. This flexible approach allows the federated API gateway system 106 to tailor responses to specific operational criteria while maintaining a consistent interface with various digital service provider systems 102.

The API response 136 is transmitted for receipt by the application executed by the client device (block 814) e.g., as a return API response (step 712). Once the API response 136 has been generated and processed by the federated API gateway system 106, the API response 136 is transmitted back to the client device 104 for receipt by the application 118. In this way, the data requested by the client device 104 is delivered back to the application 118. The response may be sent over the same network 108 that carried the initial request, utilizing protocols such as HTTPS to ensure secure data transfer.

The format and content of the API response 136 can vary depending on a nature of the original request and the specific operation criteria of the application 118. For example, in a social media application, the API response 136 may contain a JSON payload with user profile data, including name, profile picture URL, and recent activity. In a financial application, the API response 136 may include an XML document with account balance information, transaction history, and relevant warnings or notifications. The application 118 is then responsible for parsing and utilizing this response data, e.g., updating the user interface, storing information locally, triggering further application logic based on the received content, and so forth. The gateway manager system 122 may also include additional metadata with the response, such as rate limiting information, caching directives, or custom headers that provide context about the processing performed by the federated API gateway system 106.

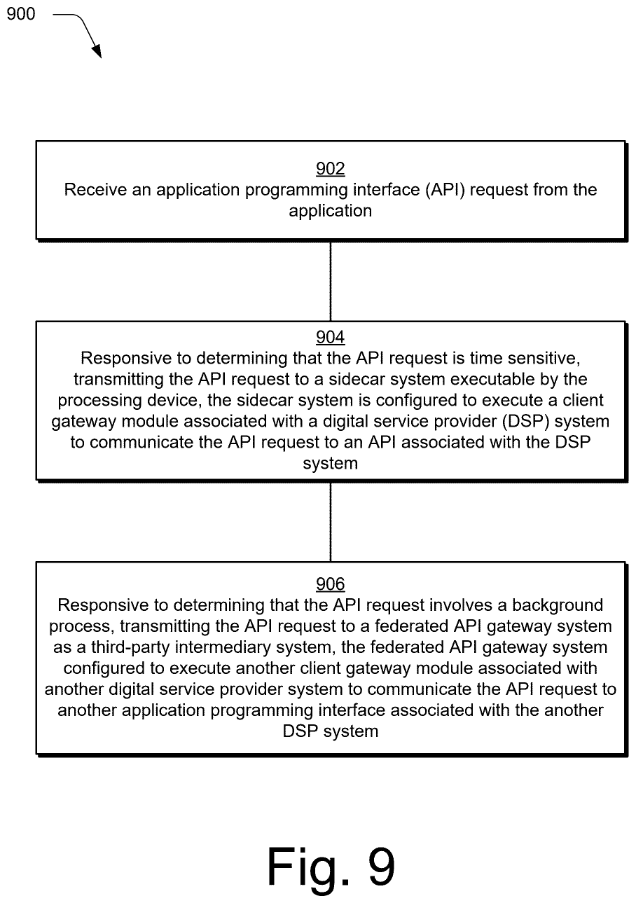

FIG. 9 is a flow diagram depicting an algorithm as a step-by-step procedure 900 in an example implementation of operations performable for accomplishing a result of API request routing through use of a federated application programming interface (API) gateway system implemented both as a third-party intermediary and as an execution plane system. The procedure 900 of FIG. 9 illustrates a hybrid routing technique for handling API requests. This technique allows for efficient processing of both time-sensitive and background API requests.

In this example, an application programming interface (API) request is received from the application (block 902). This request may originate from various components within the application, such as user interactions, automated processes, or system events. The API client module 128 within the application 118 may be responsible for generating and initiating this request.

Responsive to determining that the API request is time sensitive, the API request is transmitted to an execution plane system executable by the processing device, the execution plane system is configured to execute a client gateway module associated with a digital service provider (DSP) system to communicate the API request to an API associated with the DSP system (block 904). The execution plane system 138, which may be implemented as the execution plane system 138 with its execution plane module 140, is configured to execute a client gateway module 124 associated with a digital service provider (DSP) system 102. The execution plane system 138 then communicates the API request to an API associated with the DSP system. This approach minimizes latency for time-sensitive operations by processing the request locally on the client device 104.

Responsive to determining that the API request involves a background process, the API request is transmitted to a federated API gateway system as a third-party intermediary system. The federated API gateway system is configured to execute another client gateway module associated with another digital service provider system to communicate the API request to another application programming interface associated with the another DSP system (block 906). In this case, the API request is transmitted to a federated API gateway system 106 acting as a third-party intermediary system. The federated API gateway system 106 is configured to execute another client gateway module 124 associated with another digital service provider system. This client gateway module 124 then communicates the API request to another application programming interface associated with the other DSP system. This option is employed for non-time-sensitive operations, allowing for centralized processing and management of API requests. A variety of other examples are also contemplated.

As described herein, the federated API gateway system 106 supports a variety of technical advantages in managing and streamlining API integrations across diverse digital environments. By centralizing client generation, configuration management, and versioning control, the federated API gateway system 106 substantially reduces code duplication and inconsistencies across an organization. This centralization enables efficient updates, consistent error handling, and improved security practices across API integrations, resulting in corresponding improvements in computational resource consumption efficiency.

Furthermore, the federated API gateway system 106 supports flexible deployment options, including third-party intermediary and local execution plane system implementations, thereby allowing for optimized performance based on specific use cases. The localy deployment model as implemented by the execution plane system 138, in particular, enables time-sensitive API calls to be handled locally, minimizing network latency while maintaining benefits of centralized management.

This hybrid approach supports a variety of technical advantages, including standardized API consumption with low-latency operations, enhanced security through local data processing, and improved resilience for applications with intermittent connectivity. Extensibility of the federated API gateway system 106 through a plug-and-play framework further enhances adaptability, allowing for seamless integration of custom functionality such as caching, advanced transformations, and specialized logging which is not possible using conventional techniques. These features collectively contribute to increased efficiency, security, and scalability while addressing complex challenges faced in application development and digital service consumption.

### Example System and Device

FIG. 10 illustrates an example system generally at 1000 that includes an example computing device 1002 that is representative of one or more computing systems and/or devices that implement the various techniques described herein. This is illustrated through inclusion of the federated API gateway system 106. The computing device 1002 is configurable, for example, as a server of a service provider, a device associated with a client (e.g., a client device), an on-chip system, and/or any other suitable computing device or computing system.

The example computing device 1002 as illustrated includes a processing device 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1004 is representative of functionality to perform one or more operations using hardware. Accordingly, the processing device 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012 that stores instructions that are executable to cause the processing device 1004 to perform operations. The computer-readable storage medium is configured for storing instructions that, responsive to execution by the processing device, causes the processing device to perform operations. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing device 1004. The instructions and/or functions are executable/operable by one or more articles of manufacture (for example, one or more computing devices 1002 and/or processing devices 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

In implementations, the platform 1016 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving an application programming interface (API) request from an application executed by a client device;
selecting a client gateway module associated with a digital service provider (DSP) system based on the API request from a federated API gateway system;
forming a transformed API request by applying one or more transformations using the selected client gateway module on the API request;
generating an API response by applying the one or more transformations using the selected client gateway module on a DSP API response received from the DSP system responsive to processing the transformed API request; and
transmitting the API response for receipt by the application executed by the client device.

2. The method as described in claim 1, wherein the selecting is performed by identifying the digital service provider (DSP) system based on the API request.

3. The method as described in claim 1, wherein the selecting is performed by identifying the digital service provider (DSP) system based on an operation to be performed based on the API request.

4. The method as described in claim 1, wherein the one or more transformations include authentication of the API request.

5. The method as described in claim 1, wherein the one or more transformations include caching or rate limiting of the API request.

6. The method as described in claim 1, wherein the one or more transformations include request shaping of the API request.

7. The method as described in claim 1, further comprising transmitting the transformed API request for receipt by the DSP system via a network and receiving the DSP API response from the DSP system responsive to processing the transformed API request by the DSP system.

8. The method as described in claim 1, wherein the receiving, the selecting, the forming, the generating, and the transmitting are performed through execution of the federated API gateway system locally at the client device with the application as part of an execution plane system.

9. The method as described in claim 1, wherein the receiving, the selecting, the forming, the generating, and the transmitting are performed through execution of the federated API gateway system as a third-party intermediary system that is accessible by the client device with the DSP system via a network.

10. A method comprising:
obtaining an application programming interface (API) specification associated with an application programming interface (API) of a digital service provider (DSP) system at a federated application programming interface (API) system; and
generating a client gateway module at the federated application programming interface (API) system, the client gateway module executable to:
perform validation and schema handling based on the API specification;
receive an API request from an application and communicate the API request to the API of the DSP system; and
communicate a digital service provider (DSP) result from the DSP system back to the application.

11. The method as described in claim 10, wherein the API specification describes endpoints, parameters, and payload structures supported by an application programming interface (API) of the DSP system.

12. The method as described in claim 10, further comprising onboarding a service level agreement and wherein the generating the client gateway module is based at least in part of the service level agreement.

13. The method as described in claim 12, wherein the service level agreement specifies performance metrics, responsibilities, guarantees, penalties, reporting, issue resolution, and terms of service.

14. The method as described in claim 10, wherein the obtaining and the generating are performed through execution of the federated API gateway system locally at a client device with the application as part of an execution plane system.

15. The method as described in claim 10, wherein the obtaining and the generating are performed through execution of the federated API gateway system as a third-party intermediary system.

16. A computing device comprising:
a processing device; and
a computer-readable storage medium storing an application and instructions that, responsive to execution by the processing device, causes the processing device to perform operations including:
receiving an application programming interface (API) request from the application; and
responsive to determining that the API request is time sensitive, transmitting the API request to an execution plane system executable by the processing device, the execution plane system is configured to execute a client gateway module associated with a digital service provider (DSP) system to communicate the API request to an API associated with the DSP system.

17. The computing device as described in claim 16, further comprising responsive to determining that the API request involves a background process, transmitting the API request to a federated API gateway system as a third-party intermediary system, the federated API gateway system configured to execute another client gateway module associated with another digital service provider system to communicate the API request to another application programming interface associated with the another DSP system.

18. The computing device as described in claim 16, wherein the client gateway module is configured to conform the API request according to an API specification associated with the API of the DSP system, the API specification describing endpoints, parameters, and payload structures supported by the API of the DSP system.

19. The computing device as described in claim 16, wherein the client gateway module is configured to implement a service level agreement that specifies performance metrics, responsibilities, guarantees, penalties, reporting, issue resolution, and terms of service.

20. The computing device as described in claim 16, wherein the client gateway module is configured to implement one or more transformations to the API request, the one or more transformations including authentication of the API request, caching of the API request, or rate limiting of the API request.
